(19) United States
(12) Patent Application Publication
(10) Pub. No.: US 2011/0086158 A1
(43) Pub. Date: Apr. 14, 2011

(54) Beverage Manufacture Using a Static Mixer

(75) Inventors: Babatunde Aremu, Stratford, CT (US); Christopher Graham, Sandy Hook, CT (US)

(73) Assignee: PepsiCo, Inc., Purchase, NY (US)

(21) Appl. No.: 12/972,122

(22) Filed: Dec. 17, 2010

Related U.S. Application Data
(62) Division of application No. 11/591,442, filed on Nov. 1, 2006.

(51) Int. Cl. A47J 31/44; A23L 2/52; A23L 2/38

(52) U.S. Cl. 426/590; 426/519; 99/275

(57) ABSTRACT

Mouthfeel can be improved by processing a beverage product having an insoluble food component with a static mixer. The beverage product can be a soy beverage containing insoluble protein components. The static mixer serves to reduce the average particulate size of the insoluble food component.

### FIELD OF THE INVENTION

The present invention relates generally to beverage products, and more particularly to soy beverage products.

### BACKGROUND OF THE INVENTION

Soy products, such as soy beverages, have been associated with numerous health benefits. Studies have shown that soy consumption reduces cholesterol level, which lowers the risk of heart diseases. Soy is also a good source of protein, having low contents of carbohydrates and fat, making soy a useful component in weight control plans. Soy has also been found to be an effective substitute of dairy products, particularly with people who are lactose intolerant.

Even with all the health benefits, soy products have not been as popular as it should be. One reason may be because consumers perceive soy products to be lacking desirable texture. For example, some soy beverages have a beany taste that tends to leave an unpleasant powdery or gritty feeling on the tongue, making them unappealing to some consumers.

In addition, the production of soy beverages tends to be costly due to the complex processes and equipment involved. Typically, soy beverage manufacturing consists of the production of soymilk, addition of water and other ingredients to soymilk to achieve desirable product attributes, homogenization, sterilization and filling. Homogenizers may be located upstream or downstream of (i.e., before or after) the sterilizer. In general, homogenizers are expensive, and a downstream homogenizer is more expensive than an upstream homogenizer. Invariably, the cost of a homogenizer is a primary consideration in the decision to commit initial capital to launch a new soy project.

From the foregoing discussion, it is desirable to provide a manufacturing process for soy beverages that is both cost effective and capable of making products that have good taste.

### SUMMARY OF THE INVENTION

The present invention relates to beverage products, such as soy beverages, having improved mouthfeel, and methods and systems for producing the same. The beverage product is processed in a static mixer to reduce the average particulate size of an insoluble food component in the beverage product. Using a static mixer in the beverage processing advantageously reduces the capital expenditure and operating cost, as well as produces a beverage product with a better mouthfeel than beverages produced by conventional processes.

Generally, the beverage product is sterilized prior to the mixing. The beverage product can further be homogenized prior to the sterilization. In one example, the beverage product is sterilized after the mixing, followed by homogenization. Additionally, a system for processing the beverage product including a static mixer for reducing the average particulate size of the insoluble food component is disclosed. The system can include a sterilizer upstream of the mixer. A homogenizer can be provided upstream of the sterilizer. Furthermore, the system can also include a sterilizer downstream of the mixer and a homogenizer can be provided downstream of the sterilizer.

In one aspect, the invention relates to a method for processing a beverage. The method includes the steps of providing a beverage, homogenizing the beverage, sterilizing the beverage, and processing the beverage in a static mixer. In one embodiment, the static mixer is an aseptic static mixer and the beverage is a soy-based beverage. In addition, the step of providing a beverage can include processing ingredients, for example processing soy beans and blending with other ingredients, to produce an intermediate beverage product. The method can also include post-processing the beverage as described in further detail hereinbelow.

In various embodiments, the beverage may include a food component insoluble in the beverage and the static mixer reduces an average particulate size of the food component. The food component can include one or more of a protein, lactalbumin, egg albumin, zein, legume meal, sunflower seed, cotton seed, edible mineral salts, cereal fiber, vegetable fiber, cellulose, ground cocoa, roasted coffee, or combinations thereof. The average particulate size is about 4 μm to about 100 μm. In a particular embodiment, the average particulate size is not more than about 10 μm.

In further embodiments, the step of homogenizing the beverage can be carried out after the step of sterilizing the beverage and the step of sterilizing the beverage can be carried out after the step of processing the beverage in the static mixer. In addition, the step of homogenizing the beverage can be carried out after the step of sterilizing the beverage. In one embodiment, the step of sterilizing the beverage includes ultra high temperature treatment.

In another aspect, the invention relates to a beverage processing system for processing a beverage. The system includes a homogenization unit (homogenizer), a sterilization unit (sterilizer), and a static mixer (mixer). In one embodiment, the static mixer is an aseptic static mixer and the sterilization unit is an ultra high temperature sterilization unit.

In various embodiments, the beverage to be processed can include a food component insoluble in the beverage, where the static mixer reduces an average particulate size of the food component. The food component can include one or more of a protein, lactalbumin, egg albumin, zein, legume meal, sunflower seed, cotton seed, edible mineral salts, cereal fiber, vegetable fiber, cellulose, ground cocoa, roasted coffee, or combinations thereof. The average particulate size is about 4 μm to about 100 μm. In a particular embodiment, the average particulate size is not more than about 10 μm.

In further embodiments, the sterilization unit can be located upstream of the static mixer, and the homogenization unit can be located upstream of the sterilization unit. Additionally, the system can include a second homogenization unit located downstream of the sterilization unit. In another embodiment, the sterilization unit can be located downstream of the static mixer, and the homogenization unit can be located downstream of the sterilizer.

In yet another aspect, the invention relates to a beverage or other food product produced by the aforementioned methods and systems.

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 shows a process for forming a food product in accordance with one embodiment of the invention; and

FIG. 2 shows a production line for forming a food product in accordance with one embodiment of the invention.

### DETAILED DESCRIPTION OF THE INVENTION

The present invention relates to beverage products having improved texture or mouthfeel. In one embodiment, the beverage product comprises soy beverage. The soy beverage can include dairy-based products, such as milk. Providing a soy beverage that does not include dairy-based products is contemplated and within the scope of invention. Other types of food products, dairy-based or non dairy-based, particularly food products that include one or more insoluble food components, are also contemplated and within the scope of the invention. The food product could be in liquid form or non-liquid form. For example, the food product could be processed in liquid form to provide an intermediate product that is further processed to produce a non-liquid product, such as yogurt, ice cream, or tofu.

The insoluble food component, in one embodiment, includes a protein. The protein is derived from, for example, soy beans. Other types of insoluble food components that are difficult to dissolve in liquid or solution are also useful. Such components include, for example, lactalbumin, egg albumin, zein, legume meal, sunflower seed, cotton seed, edible mineral salts such as calcium carbonate (CaCO₃), cereal fiber, vegetable fiber, cellulose, ground cocoa, roasted coffee, or a combination thereof, depending on the food product. Typically, the insoluble food component is present in the form of emulsion droplets or fine particulates suspended in a liquid.

In accordance with the invention, a static mixer is employed to process the food product to reduce the particulate size of the insoluble food component. Various conventional static mixers for mixing fluids can be employed. Typically, the static mixer includes elements of various geometries enclosed in a tubular housing. In one embodiment, the static mixer includes six short helical mixing elements in a tubular housing. Providing other types and/or number of mixing elements is also useful. In one embodiment, the static mixer is a Kenics 1-KMR-SAN-6 made by Chemineer, Inc. The static mixer reduces the size of the emulsion droplets or particulates, in one embodiment, to an average size of about 4 μm to about 100 μm, and typically to less than about 10 μm. Reducing the size of the particulates and/or emulsion droplets has been found to improve the mouthfeel of the beverage product. The particulate size achieved by the mixing is dependant on several factors, including the extent or duration of mixing in the static mixer, the design of the static mixer and the viscosity and flow rate of the feed liquid food product.

In operation, a liquid food product is flowed through the static mixer. As the liquid is driven through the static mixer, the flow is repeatedly divided, sheared, and re-combined through the action of the mixing elements. In one embodiment, mixing at a flow rate of about 170 liters per minute (45 gallons per minute) at ambient temperature is sufficient to reduce particulate or emulsion droplet size to the desired level.

Several advantages can be achieved by using a static mixer to reduce the particulate size of the insoluble food component. One advantage will be the ability to replace a homogenizer with a static mixer. This will result in a reduction of capital expenditure and operating cost, since static mixers are typically much less expensive to procure and maintain than homogenizers. In addition, it has been found that static mixers can improve the mouthfeel of the beverage product, and minimize challenges to maintain product sterility.

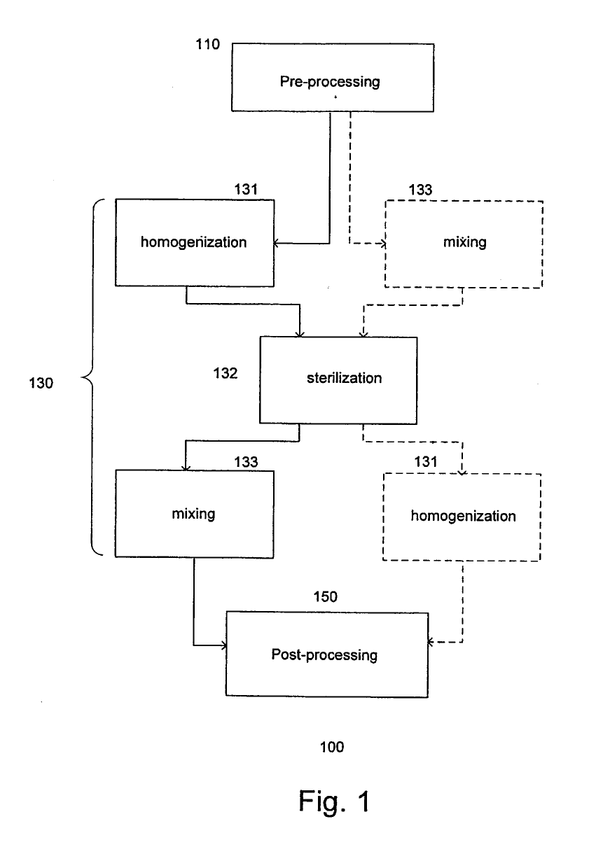

FIG. 1 shows a process 100 for forming a food product in accordance with one embodiment of the invention. In one embodiment, the process forms a soy beverage. At step 110, blending and batching are performed to produce a soy beverage. The soy beverage can be produced by adding water and other ingredients to soymilk derived from soy beans or derivatives thereof (collectively referred to as “soy material”). For example, the soy material can include whole or dehulled soy beans, defatted soy flour such as soy protein isolate, liquid soy, soy protein concentrate, soy bean flakes, or a combination thereof Other types of soy material are contemplated and within the scope of the invention.

Various conventional techniques can be employed to produce the soy beverage. Such techniques include, for example, blending, heating and cooling steps. The soy beverage can include various additional ingredients, such as vitamins, minerals, flavoring agents, sweeteners, coloring agents, stabilizers, and pH adjusters, as desired. The soy beverage includes an insoluble food component, in one embodiment. The insoluble food component includes, in one embodiment, denatured soy protein. Other types or combinations of insoluble components can also be present in the soy beverage.

At step 130, the finished soy beverage is processed. Processing includes sterilizing the soy solution at step 132. In one embodiment, the sterilization process includes ultra high temperature (UHT) treatment. The UHT treatment includes subjecting the soy beverage to high temperatures, such as by direct steam injection or steam infusion, or by indirect heating in a heat exchanger. In one embodiment, the product solution is sterilized by heating it to about 140° C. (284° F.) and maintaining that temperature for about 5 seconds. The sterilization is typically conducted in a closed system. Other sterilization techniques are contemplated and within the scope of invention.

In one embodiment, the soy beverage is homogenized at step 131 prior to sterilization. Homogenization can be performed using conventional homogenizers and processing conditions well known in the art. Homogenization serves to reduce the size of insoluble particulates or droplets present in the soy beverage prior to the sterilization step.

After sterilization, the soy beverage is mixed to dissolve or reduce the size of the insoluble particulates at step 133. Heat treatment applied during the sterilization process causes denaturing of, for example, protein components present in soy. Such denatured proteins are insoluble in the soy beverage. The mixing serves to reduce the size of insoluble particulates or droplets formed as a result of the sterilization process. In one embodiment, a static mixer is used to reduce the size of insoluble particulates. The static mixer can be, in one embodiment, a sanitary or aseptic static mixer. For example, the static mixer is a Kenics 1-KMR-SAN-6 made by Chemineer, Inc. Various other types of static mixers can also be used. The mixing is typically performed to sufficiently improve the mouthfeel of the soy beverage. The size of the insoluble droplets or particulates in the final product, in one embodiment, is about 4 μm to about 100 μm, and typically less than about 10 μm. The processing parameters can be adjusted accordingly to achieve the desired size. For example, the static mixer can be operated at about ambient temperature and a flow rate of 170 liters per minute (45 gallons per minute) to reduce the size of insoluble particulates to the targeted level.

In an alternative embodiment, step 133 for mixing the soy beverage is performed prior to sterilization while the homogenization step 131 is performed after sterilization, as indicated by the dotted-lined process flow. Mixing the soy beverage prior to sterilization advantageously increases the efficiency of the homogenization step 131.

In yet another embodiment, a first homogenization step 131 is performed prior to sterilization, followed by a second homogenization step (not shown) performed after sterilization, either prior to or after the mixing step 133.

After processing of the soy beverage is completed, it is post-processed at step 150. Post-processing includes, for example, cooling the soy beverage and filling it into containers for packaging and shipping. For instance, the soy beverage may first be pre-cooled to 75° C. (167° F.) for aseptic storage, and subsequently cooled to 25° C. (77° F.) before being transferred to a buffer tank for filling into cartons or bottles. Post-processing can also include processes for transforming the soy beverage into solid products.

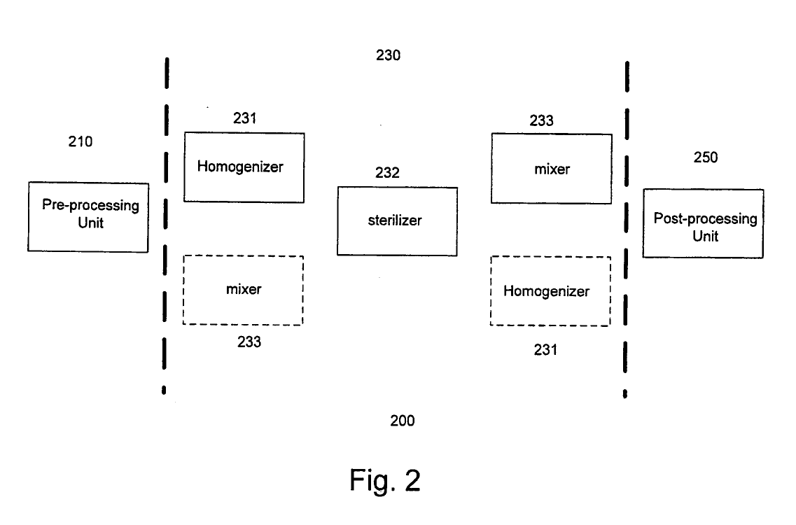

FIG. 2 shows a production line 200 for forming a beverage product in accordance with one embodiment of the invention. As shown, the production line comprises a pre-processing unit 210, a processing unit 230, and a post processing unit 250.

In one embodiment, the pre-processing unit prepares ingredients of the beverage product to form a product solution. The product solution includes insoluble food components. The product solution is processed by a processing unit that includes a static mixer. The static mixer can be any conventional static mixer that is capable of dissolving or reducing the size of the insoluble food component to improve mouthfeel of the beverage product. After processing, the product solution is passed to the post-processing unit for further processing. Further processing includes, for example, cooling and packaging the beverage product for shipping.

In one embodiment, the pre-processing unit prepares the ingredients of the beverage product to form a soy beverage. The pre-processing unit includes, for example, a bean extraction unit. A bean extraction unit typically comprises grinders to grind the beans, blending tanks, batching tanks, decanters, evaporators, heat exchangers and/or deaeration vessels. Other or different components may be provided in the pre-processing unit, depending on the beverage product to be processed.

The processing unit, in one embodiment, comprises at least one homogenizer 231, a sterilizer 232 and a static mixer 233. As shown, the homogenizer 231 is upstream of the sterilizer, while the static mixer is downstream of the sterilizer 232. Alternatively, the static mixer 233 is upstream of the sterilizer, while the homogenizer 231 is downstream of the sterilizer, as shown by the dotted lines. In yet another embodiment, a first homogenizer 231 is upstream of the sterilizer, a second homogenizer (not shown) is downstream of the sterilizer. The second homogenizer can be either upstream or downstream of the static mixer 233.

The static mixer, in one embodiment, comprises a sanitary static mixer. For example, the static mixer is a Kenics 1-KMR-SAN-6 made by Chemineer, Inc. The static mixer typically comprises six helical mixing elements enclosed within a tubular housing, the tubular housing having an inner diameter of about 23 cm (9 inches) and length of about 22 mm (0.87 inches). The mixing elements come in various sizes and geometries. Other types of static mixers are contemplated and within the scope of invention. The sterilizer, for example, comprises a UHT sterilizer. Various conventional UHT sterilizers can be used. Other types of sterilizers are contemplated and within the scope of invention. In addition, various conventional homogenizers can be used.

The post-processing unit, in one embodiment, includes a cooling unit and a filling unit. The cooling unit cools the soy product to, for example, about 25° C. (77° F.) prior to filling by the filling unit. The filled products may then be labeled and packaged for shipping.

While the invention has been particularly shown and described with reference to various embodiments, it will be recognized by those skilled in the art that modifications and changes may be made to the present invention without departing from the spirit and scope thereof. The scope of the invention should therefore be determined not with reference to the above description but with reference to the appended claims along with their full scope of equivalents.

What is claimed is:

1. A method for processing a beverage, the method comprising the steps of:
providing a beverage comprising a food component insoluble in the beverage having an average particulate or droplet size;
homogenizing the beverage;
sterilizing the beverage; and
processing the beverage in a static mixer to reduce the average particulate or droplet size of the food component.

2. (canceled)

3. The method of claim 1, wherein the static mixer is an aseptic static mixer.

4. The method of claim 1, wherein the beverage comprises a soy beverage.

5. The method of claim 1, wherein the food component comprises at least one of a protein, lactalbumin, egg albumin, zein, legume meal, sunflower seed, cotton seed, edible mineral salts, cereal fiber, vegetable fiber, cellulose, ground cocoa, roasted coffee, and combinations thereof.

6. The method of claim 1, wherein the average particulate or droplet size is about 4 μm to about 100 μm.

7. The method of claim 6, wherein the average particulate or droplet size is not more than about 10 μm.

8. The method of claim 1, wherein the step of homogenizing the beverage is carried out after the step of sterilizing the beverage.

9. The method of claim 2, wherein the step of sterilizing the beverage is carried out after the step of processing the beverage in the static mixer to reduce the average particulate or droplet size of the food component.

10. The method of claim 1, wherein the step of sterilizing the beverage comprises ultra high temperature treatment.

11. The method of claim 9, wherein the step of homogenizing the beverage is carried out after the step of sterilizing the beverage.

12. A beverage processing system for processing a beverage, the system comprising:
a homogenization unit;
a sterilization unit; and
a static mixer.

13. The system of claim 12, wherein the beverage to be processed comprises a food component insoluble in the beverage, and the static mixer reduces the average particulate size of the food component.

14. The system of claim 12, wherein the sterilization unit is located upstream of the static mixer.

15. The system of claim 14, wherein the homogenization unit is located upstream of the sterilization unit.

16. The system of claim 15 further comprising a second homogenization unit located downstream of the sterilization unit.

17. The system of claim 12, wherein the sterilization unit is located downstream of the static mixer.

18. The system of claim 17, wherein the homogenization unit is located downstream of the sterilizer.

19. The system of claim 12, wherein the static mixer is an aseptic static mixer.

20. The system of claim 12, wherein the sterilization unit is an ultra high temperature sterilization unit.

21. A beverage produced by the method of claim 1.

22. The beverage of claim 21, wherein the food component comprises at least one of a protein, lactalbumin, egg albumin, zein, legume meal, sunflower seed, cotton seed, edible mineral salts, cereal fiber, vegetable fiber, cellulose, ground cocoa, roasted coffee, and combinations thereof.

23. The beverage of claim 21, wherein the average particulate or droplet size is about 4 μm to about 100 μm.

24. The beverage of claim 21, wherein the average particulate or droplet size is not more than about 10 μm.

25. The beverage of claim 22, wherein the average particulate or droplet size is about 4 μm to about 100 μm.

26. The beverage of claim 22, wherein the average particulate or droplet size is not more than about 10 μm.
